(19) United States
(12) Patent Application Publication
(10) Pub. No.: US 2020/0015577 A1
(43) Pub. Date: Jan. 16, 2020

(54) Electronic Device Holding Apparatus

(71) Applicant: Donald Biddings, JR., Indianapolis, IN (US)

(72) Inventor: Donald Biddings, JR., Indianapolis, IN (US)

(21) Appl. No.: 16/035,682

(22) Filed: Jul. 15, 2018

(51) Int. Cl. A45F 5/02; F16C 11/04

(52) U.S. Cl. CPC A45F 5/021; A45F 2005/025; A45F 2200/0516; F16C 11/04

(57) ABSTRACT

An electronic device holding apparatus, said apparatus comprising: a flexible arm, said arm having a first end and a second end, said arm further comprising a plurality of discrete cannulated elements, said arm further comprising a single, elongated, selectively malleable, rod disposed through said cannula of said plurality of cannulated elements; a stand, said stand removably attached to said first end of said flexible arm; and a connector, said connector removably attached to said second end of said flexible arm, said connector adapted to attach to an electronic device.

### BACKGROUND

### 1. Field of the Invention

The present invention generally relates to a belt clip holder for holding and transporting an electronic device (e.g., a cellular phone, personal data assistant, handheld gaming device, etc.) not in use. The present invention specifically related to a belt clip holder stand that facilitates a use of the electronic device being supported by the belt clip holder stand.

### 2. Description of the Related Art

Currently, a person may insert a cellular phone into a belt clip holder to hold and transport the cellular phone when the person is not using the cellular phone. However, whenever the person desires to use the cellular phone, the person must remove the cellular phone from the belt clip holder and may return the cellular phone to the belt clip holder upon completion of the use of the cellular phone. Thus, prior art holders for electronic devices do not commonly allow a person to use an electronic device while wearing the same. This lack of functionality may become tedious if the person is multi-tasking in a manner that does not require constant use of the cellular phone.

Exemplary prior art devices include the following:

U.S. Pat. No. 7,191,924 discloses a cell phone holder for mounting to bicycle handlebars. The cushion includes a front socket for receiving a cell phone positioning the cell phone in front of the face of the bicyclist when in a racing position.

U.S. patent application publication no. 20160182698 discloses a hands-free electronic device holder comprises a belt having a mold at a center position, the mold having a threaded stud therein, a flexible gooseneck having a proximal end and a distal end, the proximal end having a ball insert for attachment with the belt and the distal end having a rotatable attachment means, and a holding assembly having a pair or padded clamps for adjustably holding an electronic device. The holding assembly is attached to the distal end of the flexible gooseneck. The belt is wrapped around a waist of a user. The flexible gooseneck is configured to be adjusted to any orientation to align the position of the electronic device to be at the level of the user.

U.S. Pat. No. 9,750,332 discloses an electronic device holding arm including a belt that can be releasably attached around the torso of a user; and a flexible arm attached on one end to the belt; a clamp attached to the distal end of the flexible arm, where the clamp is designed to hold a mobile electronic device. The mobile electronic device holding arm is designed to fasten around a user's torso and support a mobile electronic device in a position that it can be viewed and used by the user without the user having to use their hands to support the device.

What is needed in the art, however, is a belt clip holder stand that will enable a person to intermittently use a cellular phone or other electronic device without having the burden of removing and reinserting the cellular phone in the belt clip.

### SUMMARY

In one exemplary embodiment, the present invention is an electronic device holding apparatus that allows a person to concurrently use the device and phone, said apparatus comprising: a flexible arm, said arm having a first end and a second end, said arm further comprising a plurality of discrete cannulated elements, said arm further comprising a single, elongated, selectively malleable, rod disposed through said cannula of said plurality of cannulated elements; a stand, said stand removably attached to said first end of said flexible arm; and a connector, said connector removably attached to said second end of said flexible arm, said connector adapted to attach to an electronic device.

In another exemplary embodiment, the present invention is an electronic device holding apparatus that allows a person to concurrently use the device and phone, + said apparatus comprising: a flexible arm, said arm having a first end and a second end, said arm further comprising a plurality of discrete cannulated elements, said arm further comprising a single, elongated, selectively malleable, rod disposed through said cannula of said + plurality of cannulated elements; a belt, said belt having a buckle; a connector, said connector removably attached to said second end of said flexible arm, said connector adapted to attach to an electronic device; and means for selectively, removably attaching said first end of said flexible arm to said buckle.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

In the drawings:

FIG. 1 shows a dissembled view of an exemplary apparatus in accordance with the present invention.

FIG. 2 shows an assembled view of an exemplary apparatus in accordance with the present invention.

FIG. 3 shows the elements of a flexible arm of an exemplary apparatus in accordance with the present invention.

FIG. 4 shows a close-up view of the elements of a flexible arm of an exemplary apparatus in accordance with the present invention.

FIG. 5 shows s photograph of a prototype of a flexible arm of an exemplary apparatus in accordance with the present invention.

FIG. 6 shows an exemplary apparatus in accordance with the present invention including a stand and an electronic device connection element.

FIG. 7 shows a top view of an electronic device connection element for use with an exemplary apparatus in accordance with the present invention.

FIG. 8 shows a bottom view of an electronic device connection element for use with an exemplary apparatus in accordance with the present invention.

FIG. 9 shows a top view of stand for use with an exemplary apparatus in accordance with the present invention.

FIG. 10 shows an artist rendering of an alternative embodiment of the present invention.

FIG. 11 shows an exemplary belt for use with the apparatus of FIG. 10.

FIG. 12 shows a front view of the belt of FIG. 11 with an exemplary buckle for use with an exemplary apparatus in accordance with the present invention.

FIG. 13 shows a back view of the belt and buckle of FIG. 12.

FIG. 14 shows a close-up front view of the buckle in FIG. 11.

FIG. 15 shows a close-up back view of the buckle in FIG. 11.

FIG. 16 shows a top view of the buckle in FIG. 11.

FIG. 17 shows a bottom view of the buckle in FIG. 11.

FIG. 18 shows a first side view of the buckle in FIG. 11.

FIG. 19 shows a second side view of the buckle in FIG. 11.

FIG. 20 shows a side view of the buckle in FIG. 11 next to a flexible shaft in accordance with an exemplary embodiment of the present invention.

FIG. 21 shows a side view of the buckle in FIG. 11 attached to a flexible shaft in accordance with an exemplary embodiment of the present invention.

FIG. 22 shows a top view of the buckle in FIG. 11 next to a flexible shaft in accordance with an exemplary embodiment of the present invention.

FIG. 23 shows a top view of the buckle in FIG. 11 attached to a flexible shaft in accordance with an exemplary embodiment of the present invention.

FIG. 24 shows a front view of the buckle in FIG. 11 next to a flexible shaft in accordance with an exemplary embodiment of the present invention.

FIG. 25 shows a front view of the buckle in FIG. 11 attached to a flexible shaft in accordance with an exemplary embodiment of the present invention.

FIG. 26 shows a side view of an exemplary electronic device connector next to a flexible shaft in accordance with an exemplary embodiment of the present invention.

FIG. 27 shows a side view of an exemplary electronic device connector attached to a flexible shaft in accordance with an exemplary embodiment of the present invention.

FIG. 28 shows a top view of an exemplary electronic device connector next to a flexible shaft in accordance with an exemplary embodiment of the present invention.

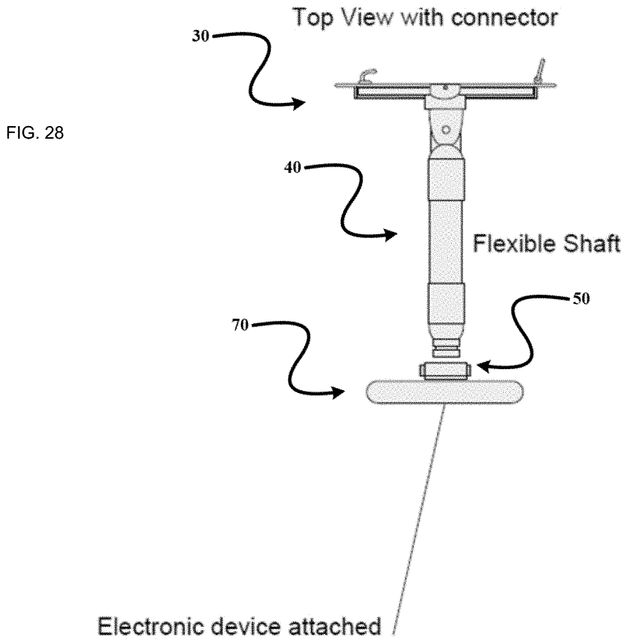

FIG. 29 shows a side view of an exemplary electronic device connector in accordance with an exemplary embodiment of the present invention.

FIG. 30 shows top, bottom, left, and right views of an exemplary electronic device connector in accordance with an exemplary embodiment of the present invention.

Corresponding reference characters indicate corresponding parts throughout the several views. The exemplary embodiments set forth herein are not to be construed as limiting the scope of the invention in any manner.

### DETAILED DESCRIPTION OF THE EMBODIMENTS

The present invention will be discussed hereinafter in detail in terms of various exemplary embodiments according to the present invention with reference to the accompanying drawings. In the following detailed description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

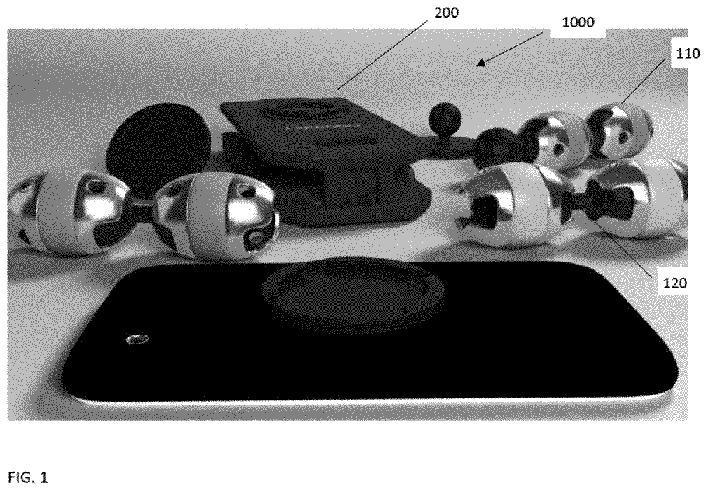

Thus, all of the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

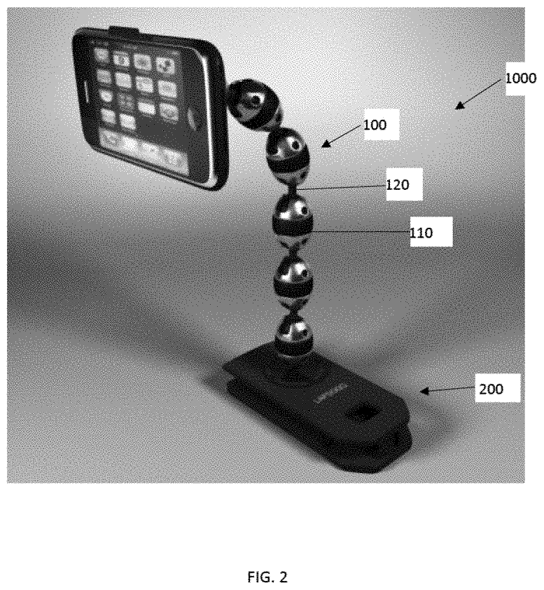

Referring first to FIG. 1 and to FIG. 2, there is shown an exemplary electronic devise holding Apparatus 1000 in accordance with the present invention. As illustrated in FIG. 2, Apparatus 1000 generally comprises flexible Shaft 100 having a first end and a second end. As further illustrated in FIG. 2, flexible Shaft 100 comprises a plurality of cannulated movable Elements 110 and a malleable Rod 120 disposed through the respective cannulas of each of the plurality of Elements 110. As will be described in more detail below, one end of flexible Shaft 100 is removably attachable to an electronic device such as a smartphone as illustrated in FIG. 2. The second end of flexible Shaft 100 is removably attachable to a Stand 200 or a belt as will be described in more detail below.

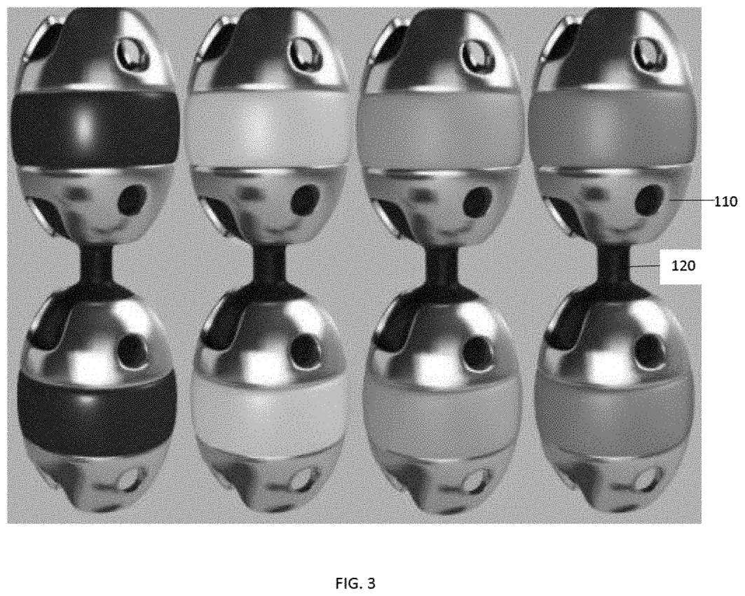

Referring now to FIG. 3, there is shown a close-up view of movable Elements 110 of that comprise flexible Shaft 100. As illustrated in FIG. 3, moveable Elements 110 preferably comprise an ovoid shape. However, Elements 110 may alternatively be sherical or cuboid in shape. As further illustrated in FIG. 3, Rod 120 is preferably a malleable metal such as copper, stainless steel, iron or nitinol that can be selectively bent and will retain its shape until a force is applied to cause it to change shape. Elements 110 are useful in manually manipulating Rod 120.

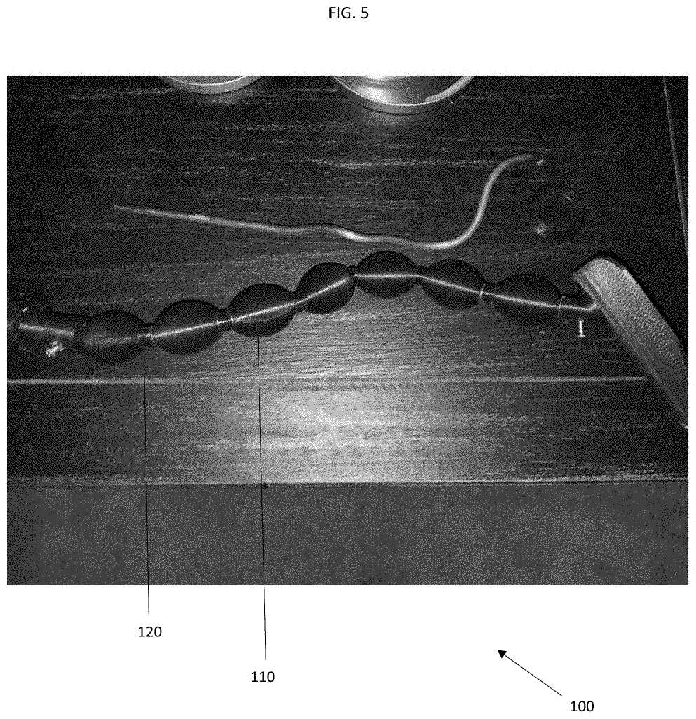

As illustrated in FIG. 5, the preferred embodiment of the flexible Shaft 100 of the present invention compromises a plurality of discrete Elements 110 preferably having an ovoid shape and a cannula disposed longitudinally through each Element 110 along the longitudinal axis of each Element 110. Malleable Rod 120 is indisposed through the plurality of Elements 110 to create flexible Shaft 100.

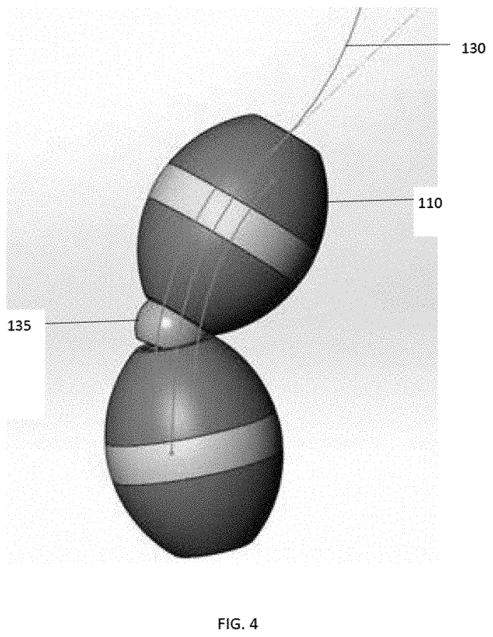

Referring next to FIG. 4, there is shown an alternative embodiment of the components making up flexible Shaft 200. As illustrated in FIG. 4, Rod 120 may be replaced with a plurality of flexible wires 121 which may be arranged in close proximity to one another as illustrated in FIG. 4. In the embodiment of FIG. 4, flexible Shaft 100 may further comprise Spacers 135 disposed between discrete Elements 110.

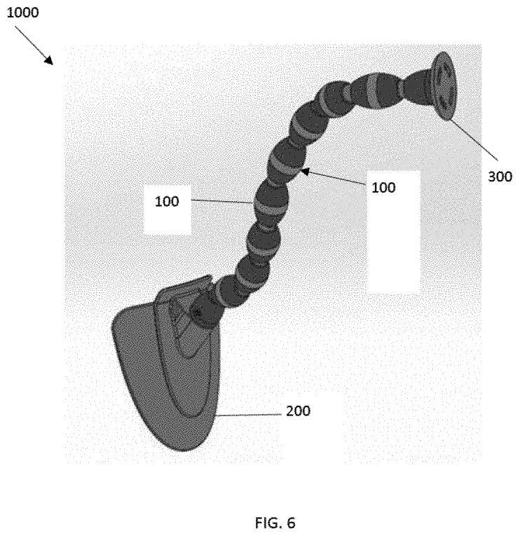

Referring now to FIG. 6, there is shown an exemplary embodiment of apparatus 1000 including flexible shaft 100 having stand 200 attached to a first end of flexible shaft 100 and Coupler 300 disposed on the second end of flexible Arm 100. Coupler 300 is adapted to connect or releasably attach to a smart phone or other electronic device.

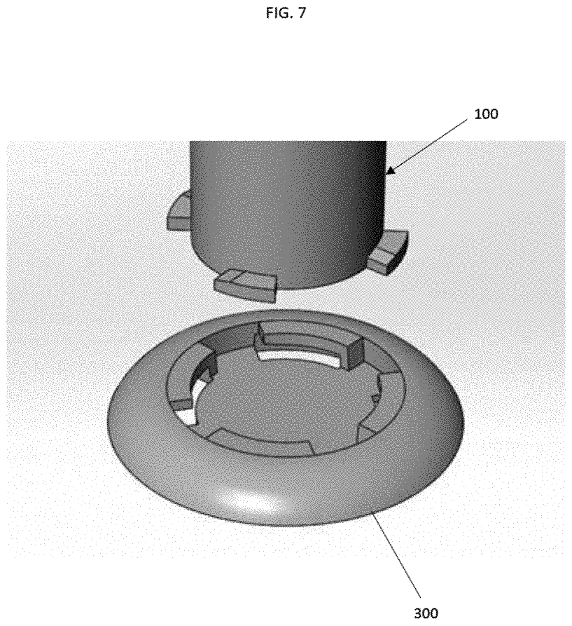

Referring now to FIG. 7, there is shown an exemplary means of connecting one end of flexible Shaft 100 to Coupler 300. As illustrated in FIG. 7, Coupler 300 is preferably generally circular in cross-section and comprises a flat side with means for connecting Coupler 300 a flat distal side and a proximal side further comprising means for connecting Coupler 300 to one end of flexible Shaft 100.

In this exemplary embodiment, means for connecting Coupler 300 to one end of flexible Shaft 100 is a tongue and groove connection between the two members. However, those who are skilled in the art will appreciate that a snap fit connection, threaded engagement, or any other releasable connection between one end of flexible Shaft 100 and one side of Coupler 300 will work with the present invention. It should be further recognized that Coupler 300 can be permanently affixed to one end of flexible Shaft 100 if desired.

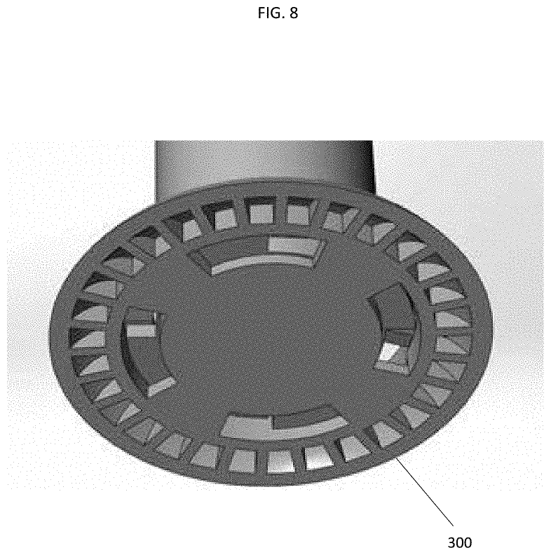

Referring now to FIG. 8 there is shown a bottom view of Coupler 300. As illustrated in FIG. 8, the bottom of Coupler 300 is generally flat but may include vents or other relief to reduce the material and/or manufacturing costs associated with same. In a preferred embodiment, Coupler 300 compromises a moldable plastic. Coupler 300 may be releasably attached by known means to an electronic device such as smart phone or other electronic device.

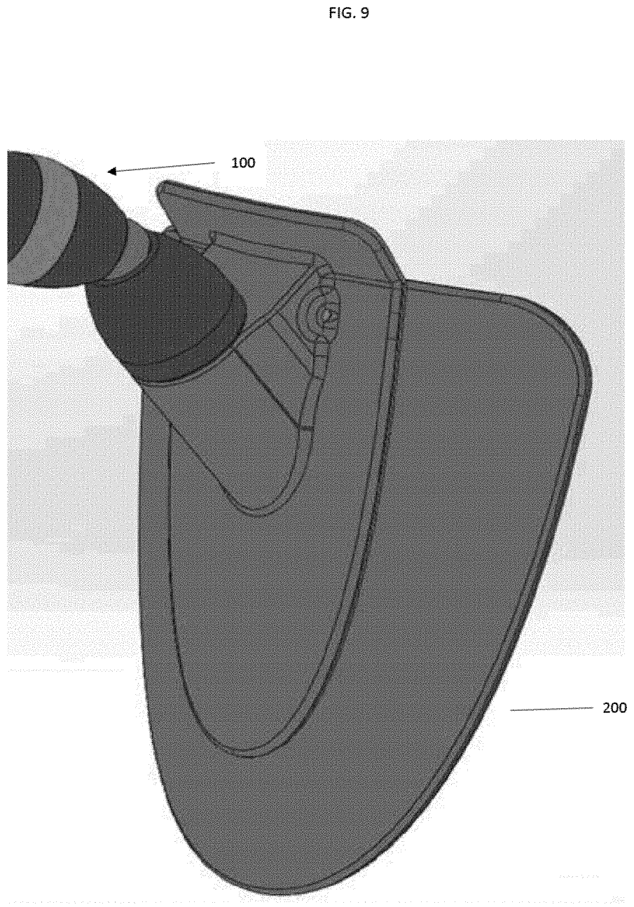

Referring now to FIG. 9, there is shown the second end of flexible Shaft 100 of a first exemplary embodiment of apparatus 1000 attached to Stand 200. Those who are skilled in the art will appreciate that any known mechanical means for selectively or permanently affixing the second end of Shaft 100 to Stand 200 may be used. Those who are skilled in the art, will further appreciate that Stand 200 may be made of any material and shape that will allow for the device to stably sit on top of a surface. Stand 200 may further comprise a bottom surface having one or more suction cups or adhesive or magnets to removably affix the same to a desired surface. Another embodiment, contemplated but not shown, Stand 200 may further comprise releasable clamps to affix Apparatus 1000 to other devices or devices with a non-uniform shape.

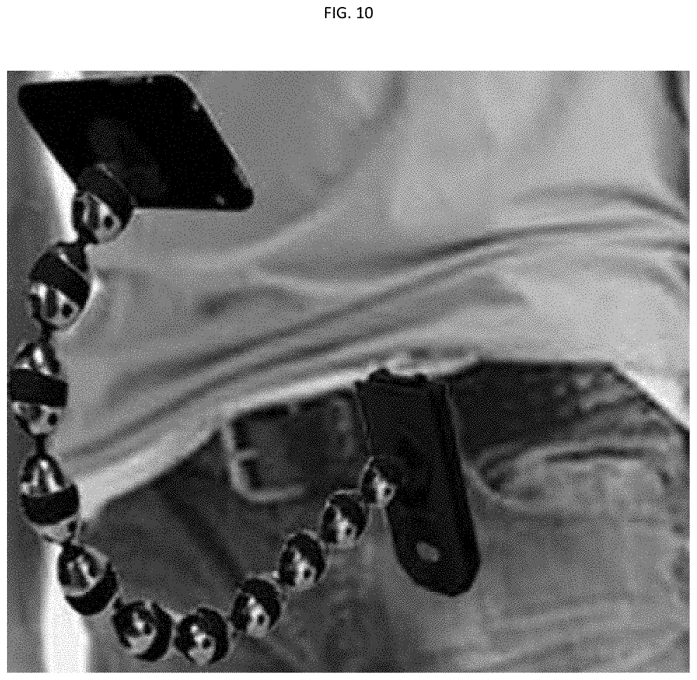

Referring now to FIG. 10, there is shown an image of an alternative embodiment of an electronic device holding apparatus 2000 in accordance with the present invention. As illustrated in FIG. 10, apparatus 2000 is adapted such that one end of flexible shaft 100 is connected to a belt and a second end of flexible shaft 100 is releasably connected to an electronic device.

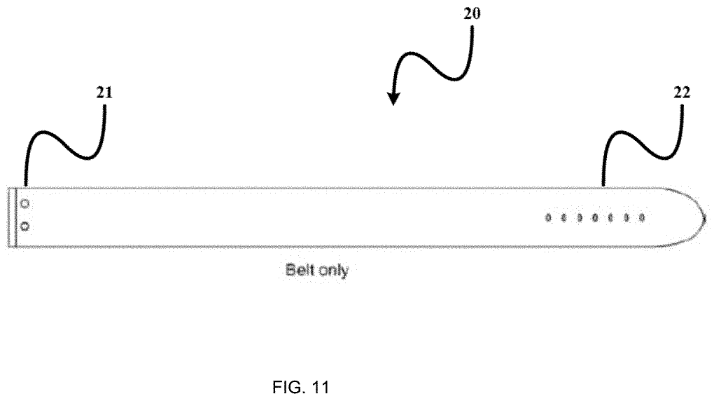

Referring now generally to FIGS. 11-13, there is shown an exemplary Belt 20 for use with Apparatus 2000. Belt 20 has a proximal End 21 to be permanently coupled to a Buckle 30 and a distal End 22 to be selectively fastened to Buckle 30 as determined by users. In practice, Belt 20 will be manufactured from canvas, nylon, leather, or any other material generally known to be used in belts. Belt 20 is preferably approximately 2 inches wide and 48 to 50 inches long.

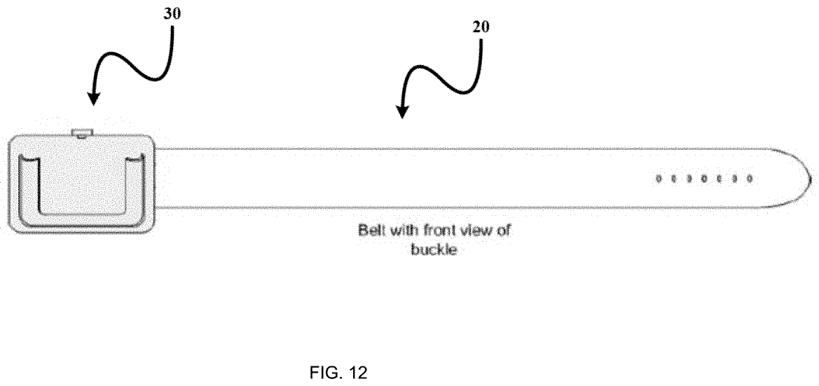

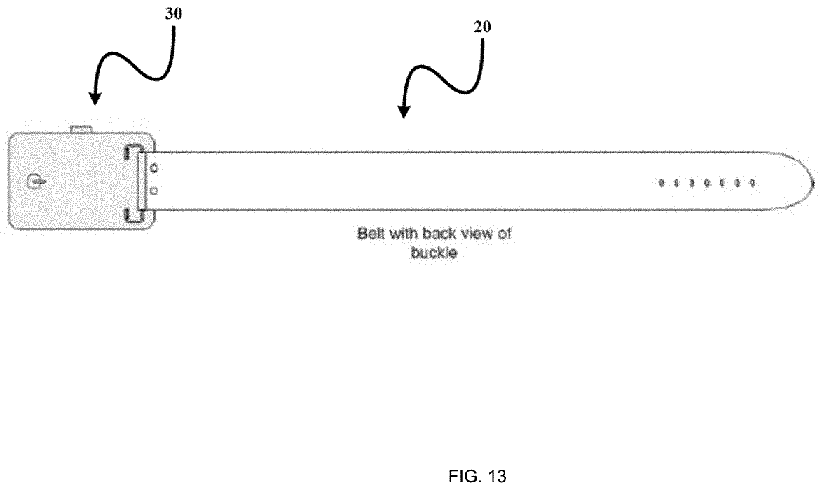

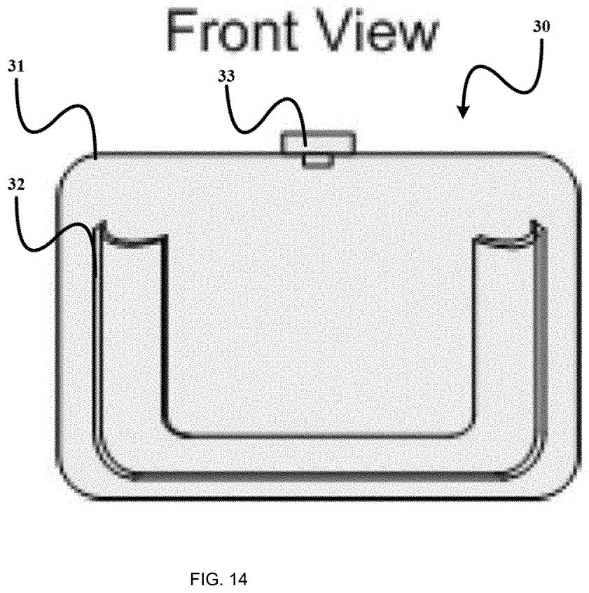

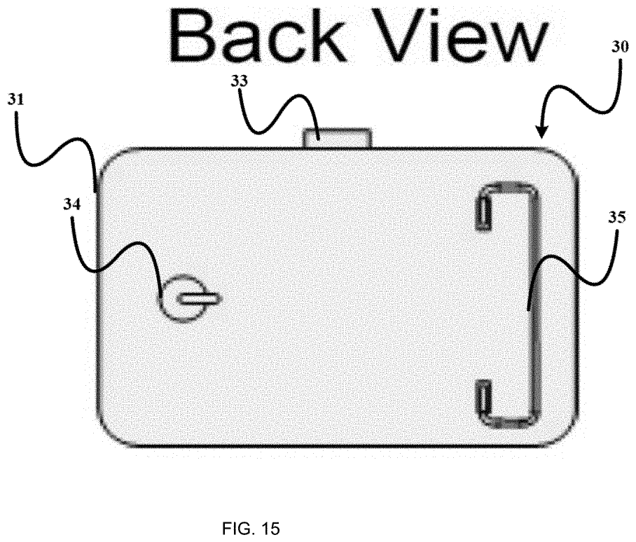

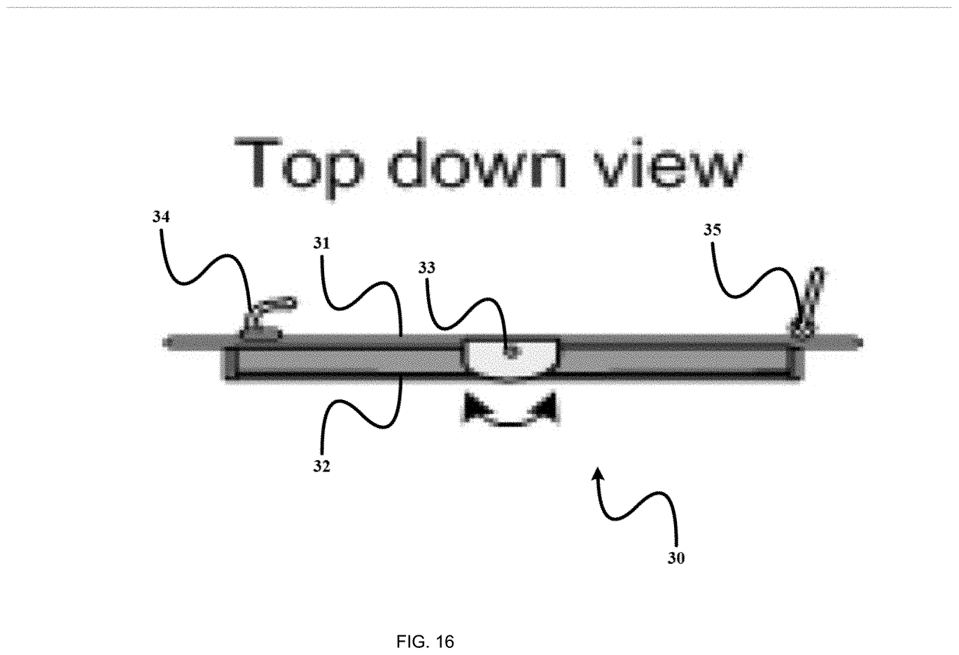

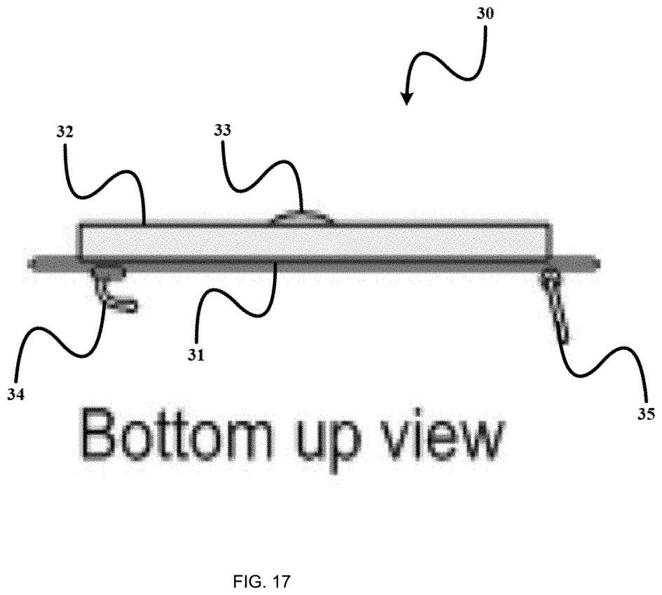

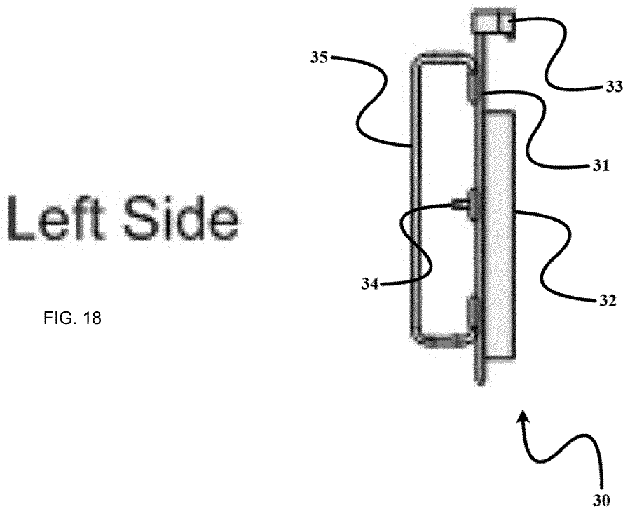

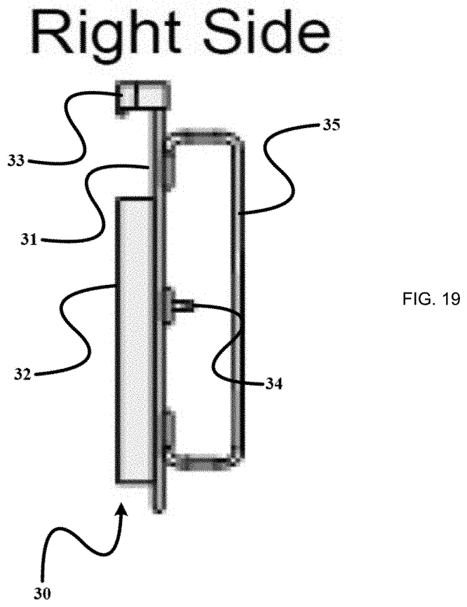

Referring now generally to FIGS. 14 through 19, Buckle 30 comprises a Base 31 and a Shaft Coupler 32 on the front side of Base 31 in the form of a slot. On top of Base 31 is a Knob 33 for selectively locking and unlocking a flexible Shaft 100 to Buckle 30. On the back side of Base 31 there is disposed a Belt Fastener 34 and a Belt Coupler 35. As shown in FIGS. 12 and 13, proximal End 21 of Belt 20 is coupled to Belt Coupler 35, and a distal End 22 of Belt 20 is selectively fastened to Belt Fastener 34. In practice Base 31, Shaft Coupler 32, and Belt Fastener 34 are preferably formed of plastic, and Belt Coupler 35 is preferably formed of metal.

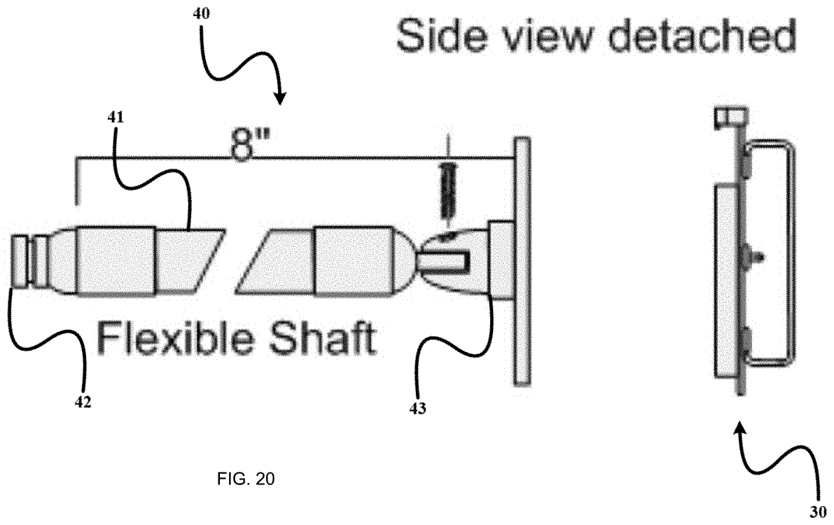

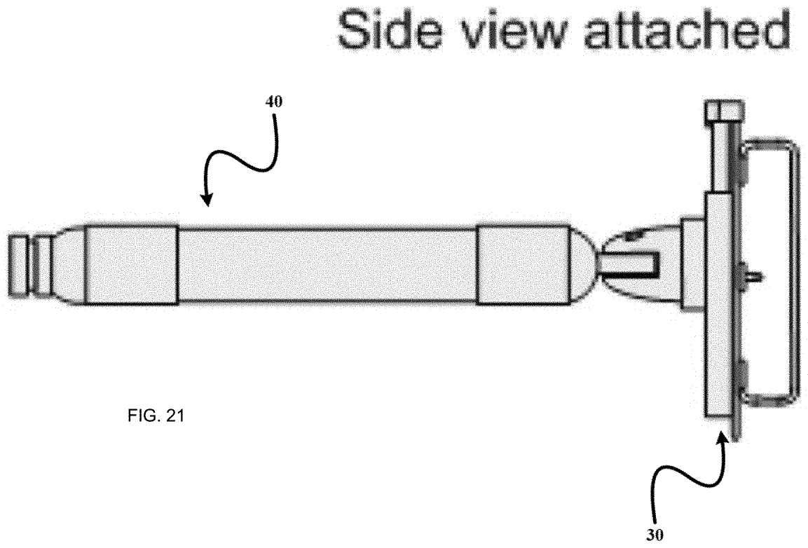

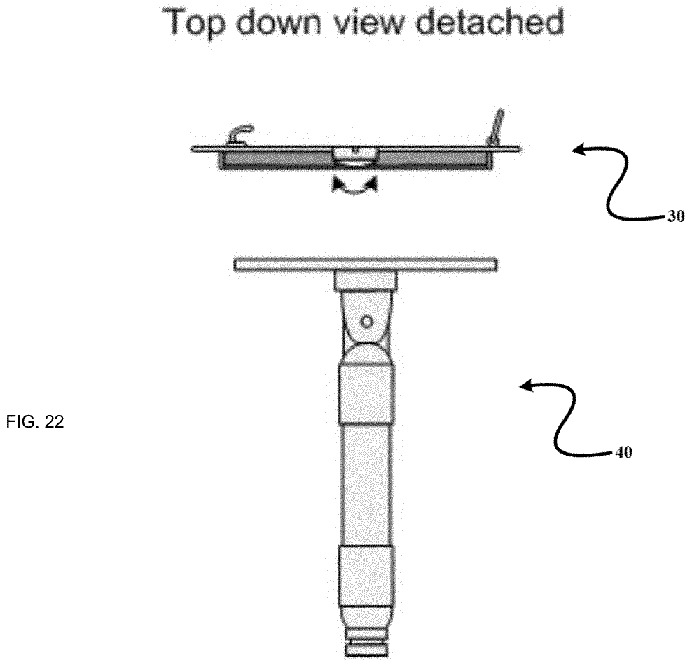

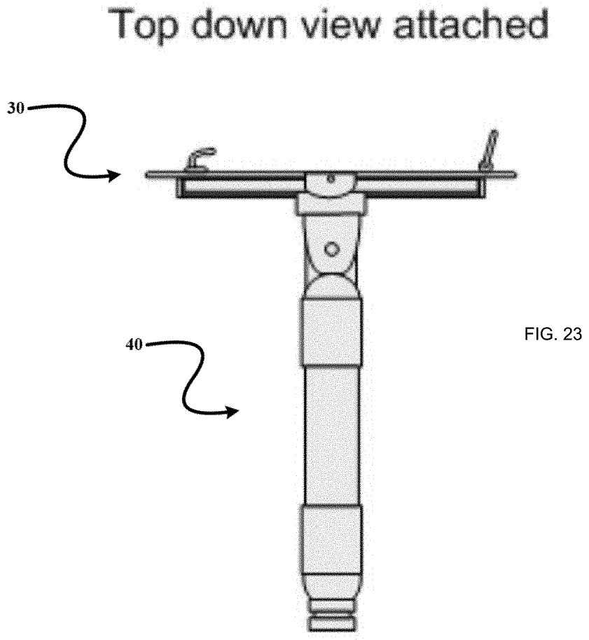

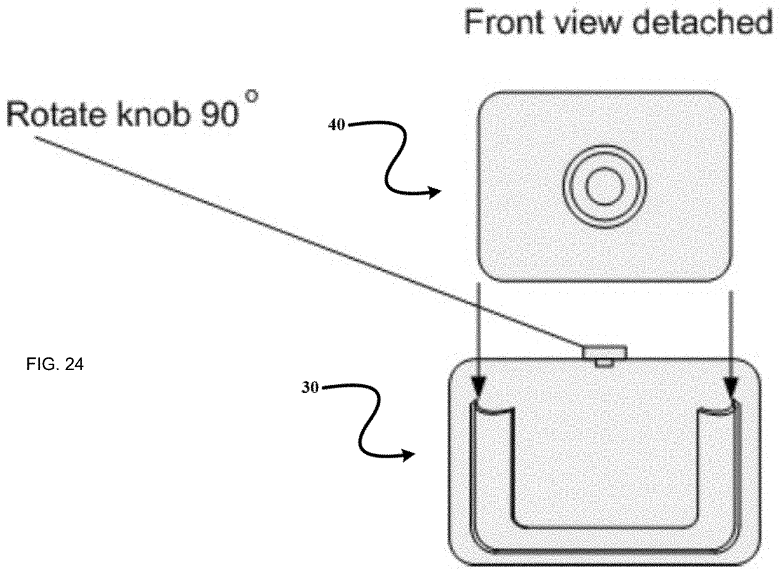

Referring now generally to FIGS. 20 through 25, there is shown an exemplary means for coupling flexible Shaft 41 to Buckle 30. In this exemplary embodiment, Knob 33 of Buckle 30 is rotated to an open position to enable Buckle Coupler 35 attach to flexible Shaft 100 to be inserted into Shaft Coupler 31. Knob 33 is then selectively rotated to a closed position to reasonably connect Buckle Coupler 35 within Shaft Coupler 31.

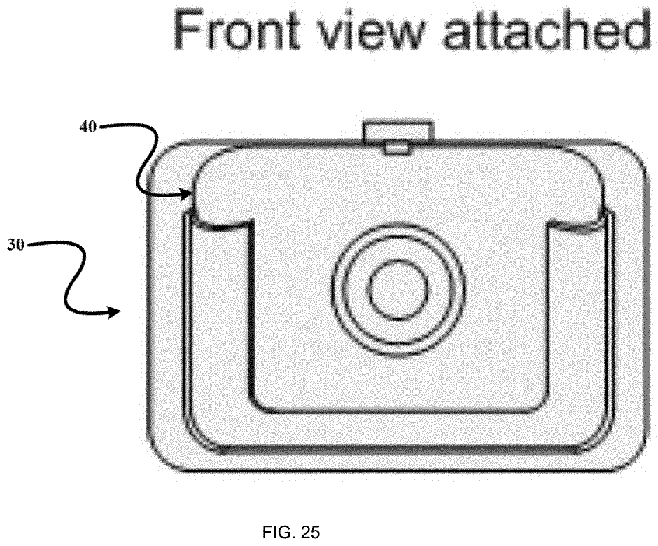

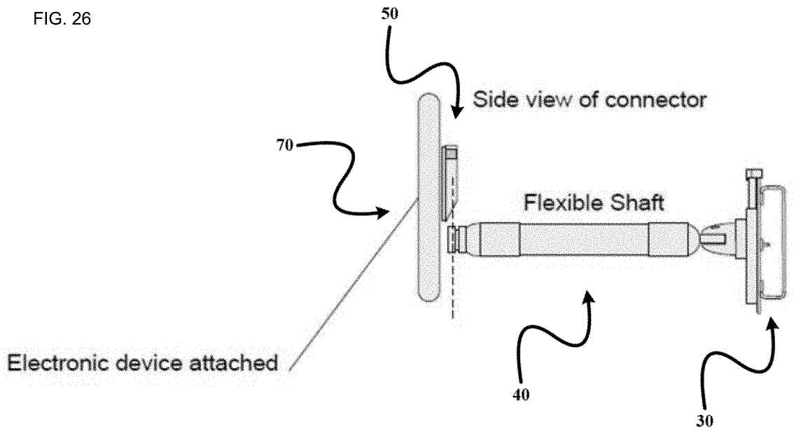

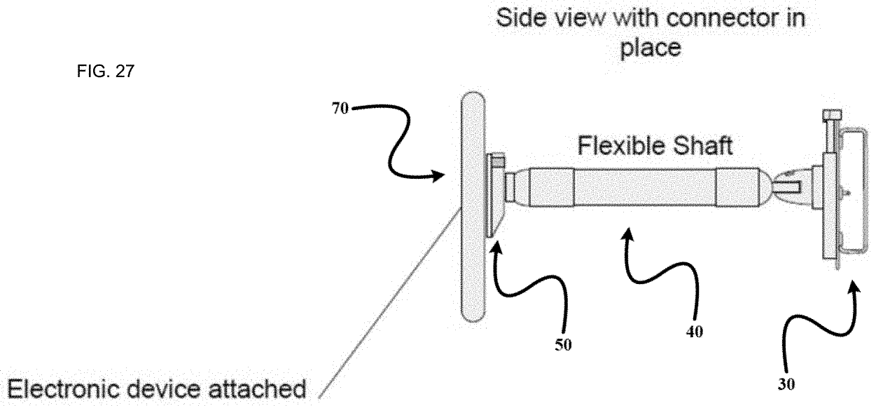

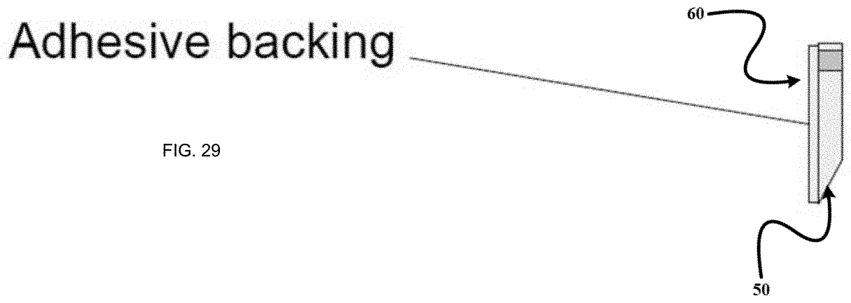

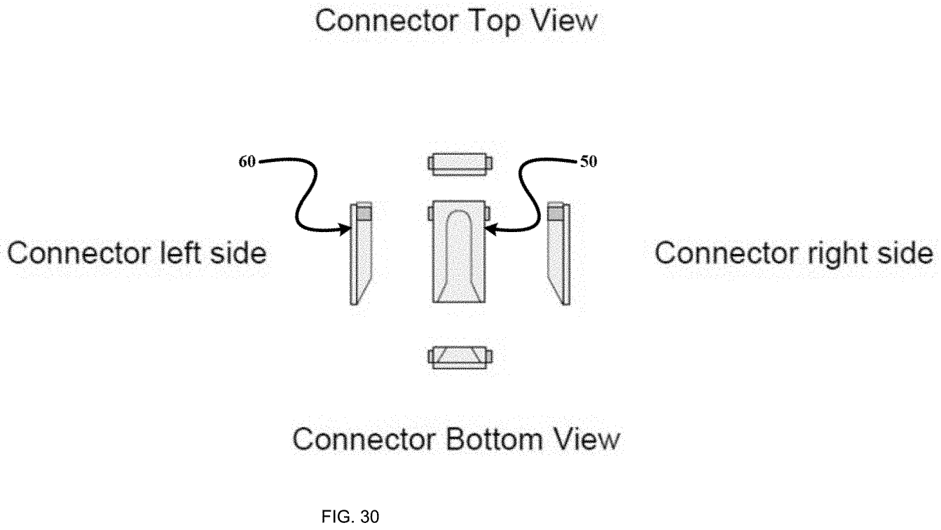

Referring now to FIGS. 29 and 30, Device Connector 50 preferably comprises a slot on the front side and Adhesive 60 mounted on the back side. To support an Electronic Device 70 (e.g., a cellular phone, personal data assistant, hand-held gaming device, et cetera), Adhesive 60 is adhered to the back of Electronic Device 70 as shown in FIG. 25 and the slot of Device Connector 50 is mounted on Holder Coupler 42 as shown in FIGS. 25 through 27. A user of Apparatus 2000 may then selectively orient mounted Electric Device 70 relative to Buckle 40 using flexible Shaft 100.

Those of skill in the art will appreciate that unlike prior art devices, a product made in accordance with the present invention can be worn by a person as he/she is using an attached cellphone, tablet, gaming Device, or other handheld electronic device.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An electronic device holding apparatus, said apparatus comprising:
a flexible shaft, said shaft having a first end and a second end, said shaft further comprising a plurality of discrete cannulated elements, said shaft further comprising a single, elongated, selectively malleable, rod disposed through said cannula of said plurality of cannulated elements;
a stand, said stand removably attached to said first end of said flexible shaft; and
a connector, said connector removably attached to said second end of said flexible shaft, said connector adapted to attach to an electronic device.

2. The apparatus of claim 1 wherein said rod comprises metal.

3. The apparatus of claim 1 wherein said rod comprises a material selected from the group consisting of copper, stainless steel, iron, and nitinol.

4. The apparatus of claim 1 wherein said stand is replaced with means for releasably connecting said apparatus to a belt.

5. The apparatus of claim 1 wherein said cannulated elements are ovoidal.

6. The apparatus of claim 1 wherein said cannulated elements comprise a shape selected from the group consisting of ovoidal, spherical, and cuboidal.

7. An electronic device holding apparatus, said apparatus comprising:
a flexible shaft, said shaft having a first end and a second end, said shaft further comprising a plurality of discrete cannulated elements, said shaft further comprising a single, elongated, selectively malleable, rod disposed through said cannula of said plurality of cannulated elements;
a belt, said belt having a buckle;
a connector, said connector removably attached to said second end of said flexible shaft, said connector adapted to attach to an electronic device; and
means for selectively, removably attaching said first end of said flexible shaft to said buckle.

8. The apparatus of claim 7 wherein said rod comprises metal.

9. The apparatus of claim 7 wherein said rod comprises a material selected from the group consisting of copper, stainless steel, iron, and nitinol.

10. The apparatus of claim 7 wherein said cannulated elements comprise a shape selected from the group consisting of ovoidal, spherical, and cuboidal.
